(19) United States
(12) Patent Application Publication
(10) Pub. No.: US 2012/0131169 A1
(43) Pub. Date: May 24, 2012

(54) SYSTEM AND METHOD FOR CONTROLLING AN UN-ADDRESSABLE NETWORK APPLIANCE

(76) Inventor: Timofei Adamovich Mouraveiko, Portland, OR (US)

(21) Appl. No.: 13/304,213

(22) Filed: Nov. 23, 2011

Related U.S. Application Data
(60) Provisional application No. 61/417,158, filed on Nov. 24, 2010.

(51) Int. Cl. G06F 15/16

(52) U.S. Cl. 709/223

(57) ABSTRACT

A network appliance is provided. The network appliance includes an un-addressable communication sub-system positioned in a communication path electronically connecting a control computing device to a target computing device that are both addressable via one or more standard networking protocols that can employed to achieve addressed communications in a structured communications network, the un-addressable communication sub-system being configured to access a data stream traveling through the communication path. The network appliance further includes memory comprising code executable by a processor to determine that a control command is present in the data stream, and permit the control command to control the network appliance only in response to an affirmative determination that the control computing device and the network appliance possess mating key portions, the mating key portions being constructed from a master key.

### CROSS REFERENCE TO RELATED APPLICATION

This application claims priority to U.S. Provisional Patent Application No. 61/417,158, filed Nov. 24, 2010 entitled “System and Method for Recording Network Data,” which is hereby incorporated by reference in its entirety for all purposes.

### BACKGROUND

Computing devices in structured communications networks, such as the Internet and virtual private networks (VPNs), may be vulnerable to attacks from computer hackers. Hackers use a variety of techniques to compromise the security of a computing device. For example, a hacker may bombard a target computing device with a multitude of passwords or variants thereof in an attempt to access the device. Packet sniffers may also be used to discover security codes, encryption techniques, etc., sent through a communication stream. The information obtained via the packet sniffer may then be used to determine an encryption algorithm or a password for targeting the device. Other techniques involve masquerading as an authorized computing device in order to intercept communications directed to a targeted computing device.

Communications networks use standardized protocols to facilitate secure and efficient communication. Among other things, this allows a large number of computing devices to participate in encrypted network communication. However, whether through benign or malicious causes, security compromise is more likely to occur when standard formats/protocols are employed. For example, public key encryption may use standardized key lengths or other standardized characteristics. As a result of this standardization, hackers may be able to much more easily recognize packets in the data stream that may contain security information (e.g., passwords, encryption protocols, etc.). The hacker may then be able to use the security information to target a computing device. Moreover, computing devices in a communications network, such as the Internet, are addressed within the network to enable communication between the devices, leaving them vulnerable to attacks from hackers through the initiation of communication with the computing device via the hacker, to ascertain weaknesses in the computing device's security.

### SUMMARY

The disclosure is directed to a network appliance and related systems/methods that make the appliance more secure and less vulnerable to compromise. In addition to being secure in and of itself, the appliance may be used in a manner that significantly increases the security of other devices that interact with the appliance. The network appliance includes an un-addressable communication sub-system positioned in a communication path electronically connecting a control computing device to a target computing device. The control and target device typically are both addressable via one or more standard networking protocols that can employed to achieve addressed communications in a structured communications network. The un-addressable communication sub-system of the appliance is configured to access a data stream traveling through the communication path connecting the controlling and targeted device. The network appliance further includes memory comprising code executable by a processor to determine that a control command is present in the data stream. The control command is permitted to control the network appliance only in response to an affirmative determination that the control computing device and the network appliance possess mating key portions which have been constructed from a master key.

By using an un-addressable component, the network appliance may be very difficult to detect, to the point that it will be difficult or even impossible for a hacker that doesn't have physical access to the appliance to even be aware that it appliance exists. Moreover, hackers cannot initiate communication with the security device without prior knowledge of the master key. Therefore, it can be extremely difficult to determine the mated portions of the master key by a hacker. Making it still more difficult for the hacker, the master key itself need not be in a standard format. Specifically, in some embodiments the master key has a format that does not conform to pre-defined network standards. When such a non-standard key is used, the difficulty of determining the mated key portions by a hacker is further increased. In fact, the master key can take virtually any form that could be imagined.

### BRIEF DESCRIPTION OF THE FIGURES

FIG. 1 shows a schematic depiction of a computing system.

FIGS. 2 and 3 show other embodiments of the computing system shown in FIG. 1.

FIGS. 4A-4C show a method for securely controlling a network appliance.

### DETAILED DESCRIPTION

A computing system for securely controlling a network appliance is described herein. The computing system includes an un-addressable network appliance that is configured to monitor a data stream traveling through a communication path in a communications network to determine if a control command is in the data stream. If a control command is in the data stream the network appliance permits itself to be controlled via the control command. The control command may include triggering functions in devices external to the network appliance, for example the control command may be used to control operation of: video-recording systems; lighting; security systems; heating/cooling in a residence; opening/closing doors; locking/unlocking doors; thermostat; etc. The control command can also be used to control and/or manage data and/or data operations in the network appliance such as copying, erasing, storing, etc. For example, in some embodiments, the network appliance acts as a data recording device that can selectively monitor and record computing activity on another device, such as a desktop computer used in the home. In this setting, control commands can be used to (a) toggle the appliance between recording and data-recovery modes; (b) turn on the recording function; (c) perform analysis on recorded data; (d) cause the data to be transferred to another location (e.g., a secure off-site server) for analysis; etc. These are non-limiting examples—the secure network appliance may be configured in a myriad of different ways and with a wide range of functionality.

When the network appliance is un-addressed hackers may not even know the network appliance is positioned in the network. Even if a hacker does know the location of the network appliance in the communications network, the hacker cannot initiate addressed communication with the network appliance to determine the appliance weaknesses/vulnerabilities (because the security component of the appliance is non-addressed). As a result, the security of the network appliance may be drastically superior to an addressable device in a structured communications network, such as an addressed computing device in a virtual private network (VPN).

A further option for increasing security is to embed the control command in a communication packet such as an Internet Protocol (IP) packet or a malformed packet. Thus, the control command may be stealthily disguised in the communication packet, thereby decreasing the likelihood that a hacker can recognize the control command in the data stream sent through the communication path.

The control command may also be encrypted via a first portion of a key stored in the memory of the control computing device, the first portion of the key having non-standard characteristics. The control command may be decrypted via a second portion of the key mated to the first portion and stored in memory in the network appliance. When a non-standard key is used it may be hard to deduce that the control command is an encrypted trigger.

Further still, in some embodiments the encryption may be time dependent. That is to say, encryption and decryption techniques used via the control computing device and the network appliance may be altered at predefined time intervals. As a result, it may be extremely difficult for a hacker to determine the encryption and/or decryption algorithm before the algorithms are altered.

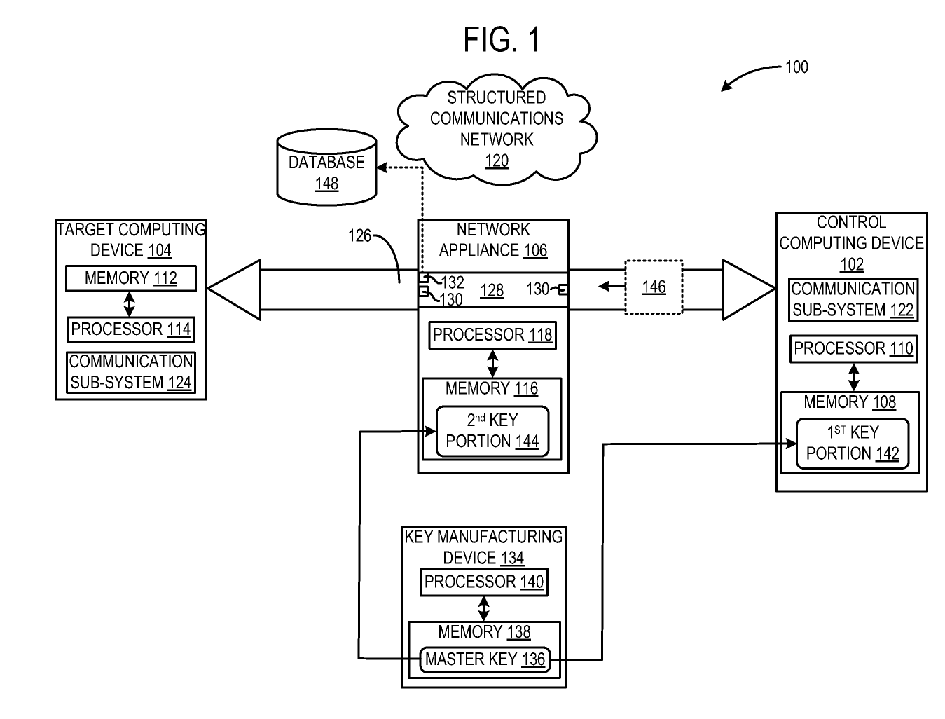

FIG. 1 shows the architecture of an example system 100. The computing system 100 includes a control computing device 102, a target computing device 104, and a network appliance 106. The control computing device 102 includes memory 108 and a processor 110. Likewise the target computing device 104 includes memory 112 and a processor 114, and the network appliance 106 also includes memory 116 and a processor 118. The memories (108, 112, and 116) may comprise code executable via the processors (110, 114, and 118, respectively) to implement the various functionalities that are discussed in detail herein. Although each device/appliance is depicted as having a single processor, it will be appreciated that a plurality of processor may be included in the control computing device 102, the network appliance 106, and/or the target computing device 104.

The target computing device 104 and the control computing device 102 are positioned in a structured communications network 120. The structured communications network 120 may include a plurality of devices, components, etc., that provide addressable communication between computing devices in the network. Thus, communication packets are sent to specified (e.g., addressed) destinations in the structured communications network 120. The components and devices in the structured communications network 120 may include routers, communication lines (e.g., Ethernet lines, coaxial lines, telephone lines, etc.). It will be appreciated that data may be difficult to intercept, tap, and filter in communication lines. Other devices may be included in the structured communications network 120, such as wireless routers and wireless receivers that are configured to turn wireless signals into a wired signal. In this way, wireless signals may be turned into a structured communication. The target computing device 104 and the control computing device may electronically communication via the structured communications network 120. The structured communications network 120 may be the Internet, a VPN, a Local Area Network (LAN), or a combination thereof. Furthermore, the structured communications network 120 may include various devices such as switches, Voice over Internet Protocol (VoIP) devices, etc. One or more service providers (e.g., Internet service providers) may provide the control computing device 102 and/or the target computing device 104 access to the structured communications network 120.

The control computing device 102 and the target computing device 104 are addressable within the structured communications network 120. Thus, the control computing device 102 may initiate communication with the target computing device 104 via unique identifiers or vice-versa. The address may be an IP address, a Media Access Control (MAC) address, or other unique identifier used in the structured communications network 120.

The control computing device 102 includes a communication sub-system 122. Likewise, the target computing device 104 includes a communication sub-system 124. The communication sub-systems (122 and 124) each may include a modem or other suitable components for providing the aforementioned functionality and electronically coupling the devices to the structured communications network 120.

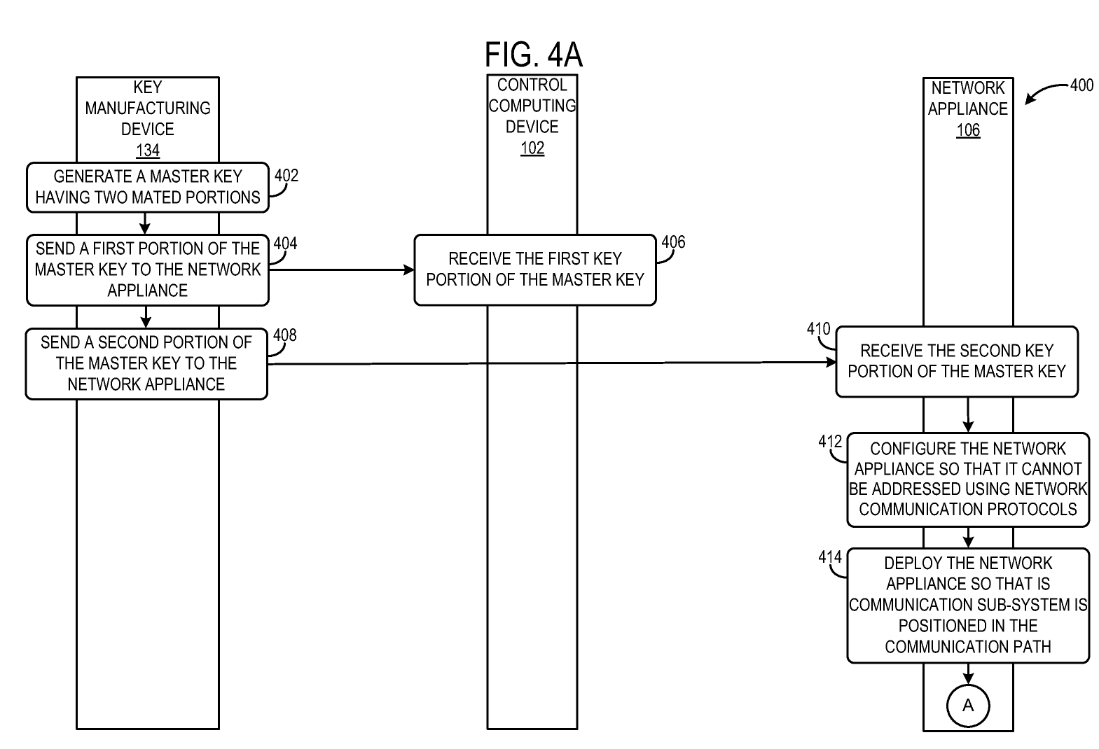

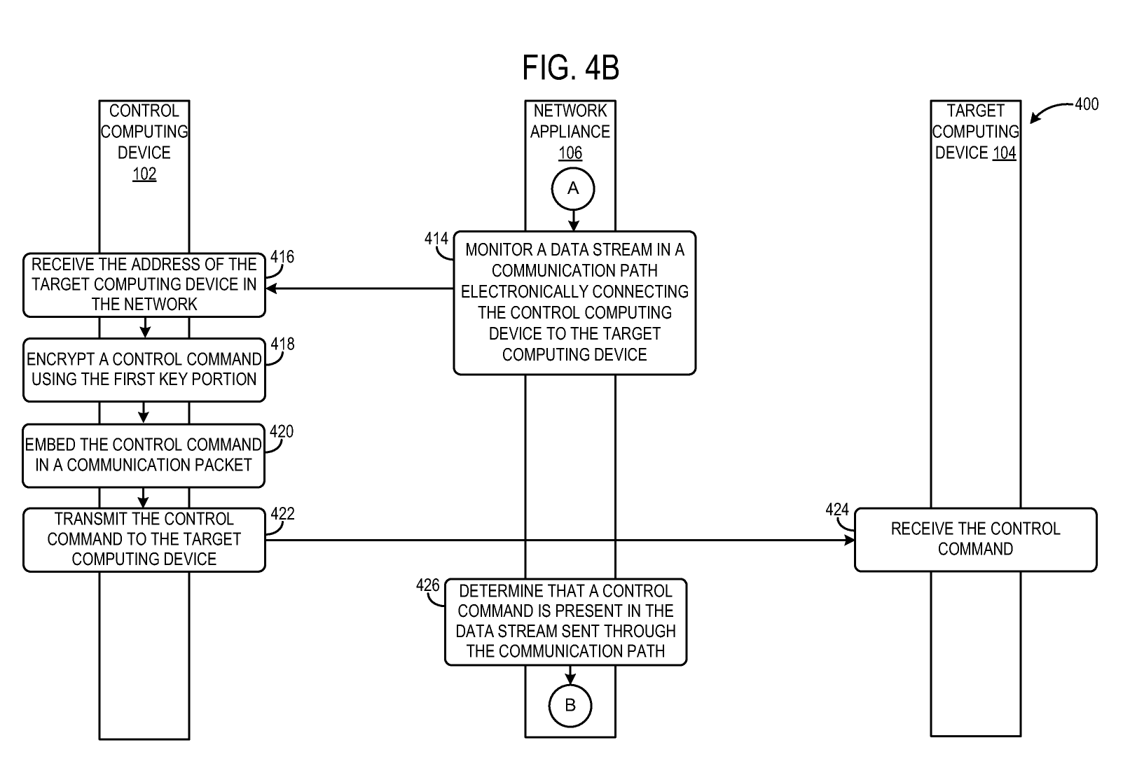

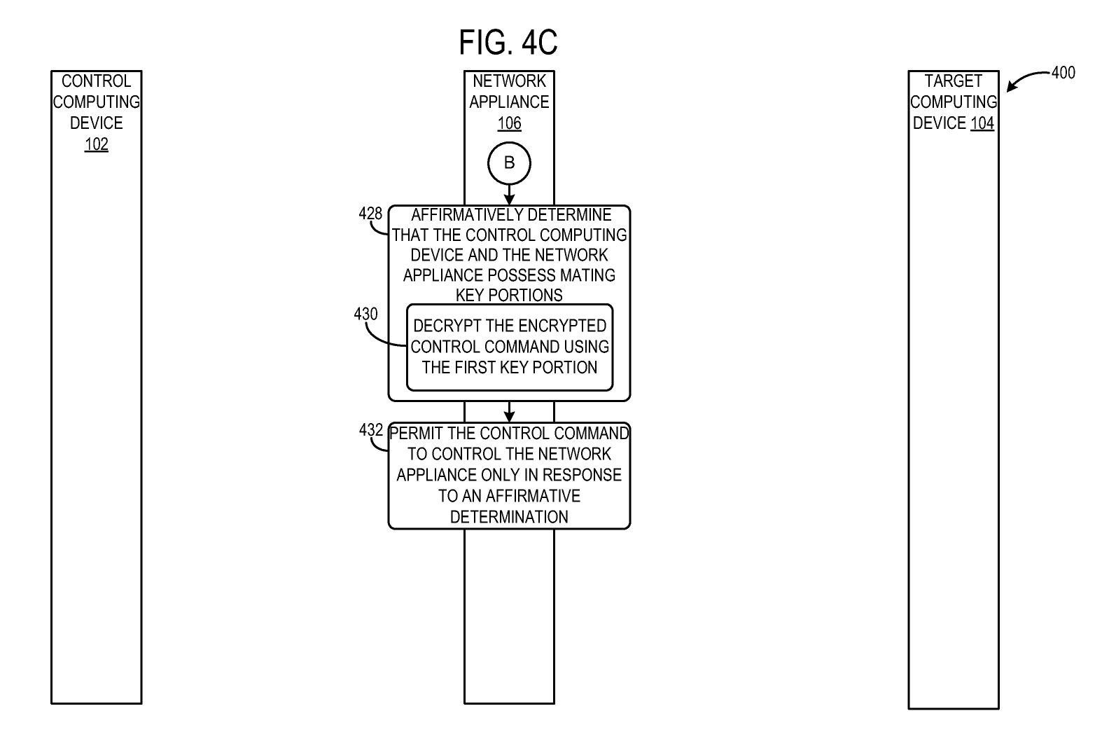

However, the network appliance 106 is un-addressable in the structured communications network 120. This means that a communication link cannot be established between the network appliance 106 and computing devices in the structured communications network 120, other than the control computing device 102. The secure technique that is used to send communications from the control computing device 102 to the network appliance 106 is discussed in greater detail herein, with regard to FIG. 4. Therefore, computing devices in the structured communications network other than the control computing device 102 cannot initiate communication with the network appliance 106 via standard networking protocols. Standards networking protocols include Internet Protocols (IPs) such as Voice Over Internet Protocol (VoIP), Session Initiation Protocol (SIP), Hypertext Transfer Protocol (HTTP), Transmission Control Internet Protocol (TCP/IP), Internet Control Message Protocol (ICMP), Simple Mail Transfer Protocol (SMTP), and POP2. Thus, the network appliance 106 is essentially hidden to computing devices in the structured communications network 120. Moreover, the network appliance 106 does not have any unique identifiers, such as an IP address and a MAC address, that can be used to address the network appliance and prompt a communication dialogue. In this way, hackers cannot initiate communication with the network appliance 106, thereby increasing the security of the network appliance. Furthermore, the location of the network appliance 106 may be difficult for a hacker to ascertain when the network appliance 106 is un-addressable.

The network appliance 106 is positioned in a communication path 126 within the structured communications network 120 electronically connecting the control computing device 102 to the target computing device 104. The communication path 126 may include wired paths and/or wireless paths linking the control computing device 102 to the target computing device. Wire paths include Ethernet cables, fiber optic cables, phone lines, coaxial cables, etc. Wireless paths include radio, infrared, ultrasonic, and/or other suitable forms of wireless signal transmission. Furthermore, the network appliance 106 may be associated with either the target computing device 104 or the control computing device 102. That is to say that the network appliance 106 is in close proximity in the communication path 126 to the associated computing device. For example, the network appliance 106 and the associated computing device may be co-located in a building or room.

In some examples, the network appliance 106 may be coupled to an external power source (e.g., wall outlet, power strip, etc.) or alternatively the network appliance 106 may include it own internally located power source (e.g., battery module). The network appliance 106 further includes a communication sub-system 128 positioned in the communication path 126. Specifically, the communication sub-system includes two communication ports 130 positioned in the communication path 126 in the depicted embodiment. However, in other embodiments the communication ports may be omitted from the communication sub-system 128.

The communication sub-system 128 may act as an unobtrusive intermediary. For example, the communication sub-system 128 may not alter a data stream sent through the communication path 126, in some examples. Additionally, the communication sub-system 128 is configured to access a data stream sent through the communication path 126. In this way, the network appliance 106 can monitor traffic sent through the communication path 126. The communication sub-system 128 may include a third port 132. The third port 132 may be electronically connected to the structured communications network 120. Additionally, the third port 132 may be used to initiate communication with other devices in the structured communications network 120, such as computing devices, servers, databases, etc.

The computing system 100 further includes a key manufacturing device 134 configured to generate a master key 136. The key manufacturing device 134 may be a computing device having code stored in memory 138 executable via a processor 140 to generate and store the master key 136 in the memory. Further in some examples, the key manufacturing device 134 may also include components configured to transfer the master key to a portable storage device (e.g., Universal Serial Bus (USB) drive, and optical disk) and/or manufacture the portable storage device itself.

The master key 136 may be in a format that does not conform to pre-defined network standards. The pre-defined network standards may include the length of the key, the key sequence, and the type of key encryption. Therefore, generating the master key 136 may include selecting a non-standard set of key characteristics. In this way, the characteristics of the master key may be unique. Customers purchasing the network appliance 106 may select the characteristics. In this way, the key characteristics may be tailored to the customer's predilection. The master key may include an encryption algorithm, a decryption algorithm, an encryption data array, and a decryption data array. Furthermore, the encryption algorithm and the decryption algorithm are mated. The encryption data array enables the encryption algorithm to encrypt data. Likewise, the decryption data array enables the decryption algorithm to decrypt data. The master key may also include timing and sequencing elements configured to alter the encryption and decryption algorithms at time intervals that may be predetermined. In this way, the encryption and decryption algorithms may be very hard to determine.

A first key portion 142 may be transferred to the control computing device 102. The first key portion 142 may include the encryption algorithm and the encryption data array. Likewise, a second key portion 144 of the master key 136 may be transferred to the network appliance 106. The second key portion 144 may include the decryption algorithm and the decryption data array. It will be appreciated that both the transfer to the control computing device 102 and the network appliance do not occur in the structured communications network 120. As a result, the master key 136 cannot be obtained via hackers in the structured communications network, thereby increasing the security of the computing system 100.

Conversely, the transfer of the first and/or second key portions (142 and 144) to the control computing device 102 and the network appliance 106, respectively, may occur through delivery of a portable storage device (Universal Serial Bus (USB) flash drive, an optical disk, an external hard drive) via a package delivery service (e.g., United States Postal Service®, FedEx®, United Parcel Service®) or other suitable mode of transportation to the owner(s) of the network appliance 106 and the control computing device 102. The transfer of the first and/or second key portions (142 and 144) to the network appliance 106 and the control computing device 102 may also occur during manufacturing of the network appliance 106 and/or the control computing device 102. Therefore, the first and/or second key portions (142 and 144) may be electronically transferred or physically inserted into the network appliance 106 and the control computing device 102, respectively, via a port such as a disk drive, a USB port, etc., in a manufacturing facility.

The first and second key portions (142 and 144) are mated to enable encryption and decryption of data. Thus, the first key portion 142 may be configured to implement the encryption algorithm. On the other hand, the second key portion 144 may be configured to implement the decryption algorithm. In this way, the key portions (142 and 144) provide a secure method of encrypted communication between the control computing device 102 and the network appliance 106. The first key portion 142 may be used to encrypt a control command sent from the control computing device 102 to the target computing device 104.

Further in some embodiments, the encryption carried out by the first key portion 142 and the decryption carried out by the second key portion 144 may be time dependent. That is to say, encryption and decryption techniques used via the control computing device 102 and the network appliance 106 may be altered at predefined time intervals. As a result, it may be extremely difficult for a hacker to determine the encryption and/or decryption algorithm before the algorithms are altered, further increasing the security of the network appliance 106.

To control the network appliance 106, the control computing device 102 may address a control command 146 to the target computing device 104. The address of the target computing device 104 may be known to a user of the control computing device 102 and therefore, the user may enter the address into the control computing device 102 via a keyboard or other suitable input device. Thus, the communication path 126 in which the network appliance 106 is positioned is known in advance by the user.

In some embodiments the control command 146 may be embedded in a communication packet addressed to the target computing device 104. Moreover, the first key portion 142 may be used to encrypt the control command 146. When the control command 146 or communication packet is sent to the target computing device 104 it is sent through the communication path 126 in which the network appliance 106 is positioned.

The network appliance 106 is configured to recognize that control command 146 is sent through the communication path 126. Once, the recognition of the control command occurs, the network appliance 106 may decrypt the control command using the second key portion 144.

In response to the recognition and the decryption, the network appliance 106 is controlled via the control command 146. Controlling the network appliance 106 includes controlling an operation associated with a computer-activity-recording capability of the network appliance. This includes turning on recording of a data stream passing through the communication path 126, turning off recording of a data stream passing through the communication path 126, sending recorded data offsite for analysis, analyzing recorded data, and processing recorded data. Specifically, the network appliance 106 may be configured to create an exact copy of the complete strata of data that passes through the network appliance 106. The complete strata may include of the inbound and outbound packets, requests, and commands. Thus, the network appliance 106 may be configured to record two-way data traffic passing through the appliance. The recorded data may be encrypted and/or sent to a database 148 external to the network appliance 106.

In particular the network appliance 106 may be configured to continuously record data passing through the network appliance 106 when it is operational (e.g., receiving power) without pause. The types of recorded data may include packets, commands, transmissions, etc. Only a small number of events may disrupt data recording in the network appliance 106. These events may include loss of power to the network appliance 106, reaching or surpassing the network appliance's storage capacity, and/or disconnection of the network appliance from the structured communications network 120. In some examples the user of network appliance 106 may be alerted when the data recording is disrupted via the loss of the user's network connection. In other words, the network appliance 106 may be configured to inhibit data transfer through the appliance when the appliance does not have power, the device has been disconnected from either the structured communications network 120 and/or the appliance has reached its storage capacity threshold. However in other examples the network appliance 106 may be configured to passively alert the user of recording disruption. For example, a user may be provided with a message alerting them of a recording disruption via the user's computing device.

The data collected by network appliance 106, via recording, may be stored in a pre-indexed manner, facilitating easy retrieval. Furthermore, the data collected by the network appliance 106 may also be encrypted. When collecting, indexing, and/or storing the data the network appliance may be operated to reduce and in some cases minimize caching in the memory 116. In this way, if power to the network appliance 106 is disconnected or interrupted, only a small amount of information capture would be lost. Moreover, the data indexes may be updated and re-written when new information is saved on to a storage device, allowing the indexes of data to be coherent in the event of a power loss or power interruption. Further in some examples, the data may also be divided into sections with checksumming. In the event of storage device failure, the corrupt data may be isolated and not compromise the rest of the data stored on the storage device.

Further in some examples, when data is corrupted in network appliance 106 the appliance may be configured to restore data on a storage device. Restoration of the data on the storage device may include matching the pattern using checksum sequentially and/or randomly in an attempt to find a pattern that matches. Once the network appliance 106 finds a matching pattern, it has found a valid chunk of data. For instance, the network appliance may check the storage device sequentially, finding the first segment of data and then attempting to find the second segment. If the network appliance cannot find the second segment, it will continue further in the sequence. Once the network appliance finds the third segment it may deduce that the second segment is corrupted.

Controlling the network appliance further includes managing data stored in the network appliance. Managing data including deleting, modifying, copying, overwriting, and moving data stored in the network appliance 106. Controlling the network appliance 106 may also include controlling one or more devices that are external to the network appliance. The one or more devices that are external to the network appliance may be at least one device that controls or manages physical security of a structure, such as a lock and a video camera. Other external devices may include a lighting fixture and a camera, a fax machine, and a printer.

Controlling the network appliance may also include initiating two-way communication with the target computing device 104 and/or the control computing device 102. Data send from the network appliance 106 to the target computing device 104 and/or the control computing device 102 may be embedded in a communication packet, such as a malformed packet to disguise the data.

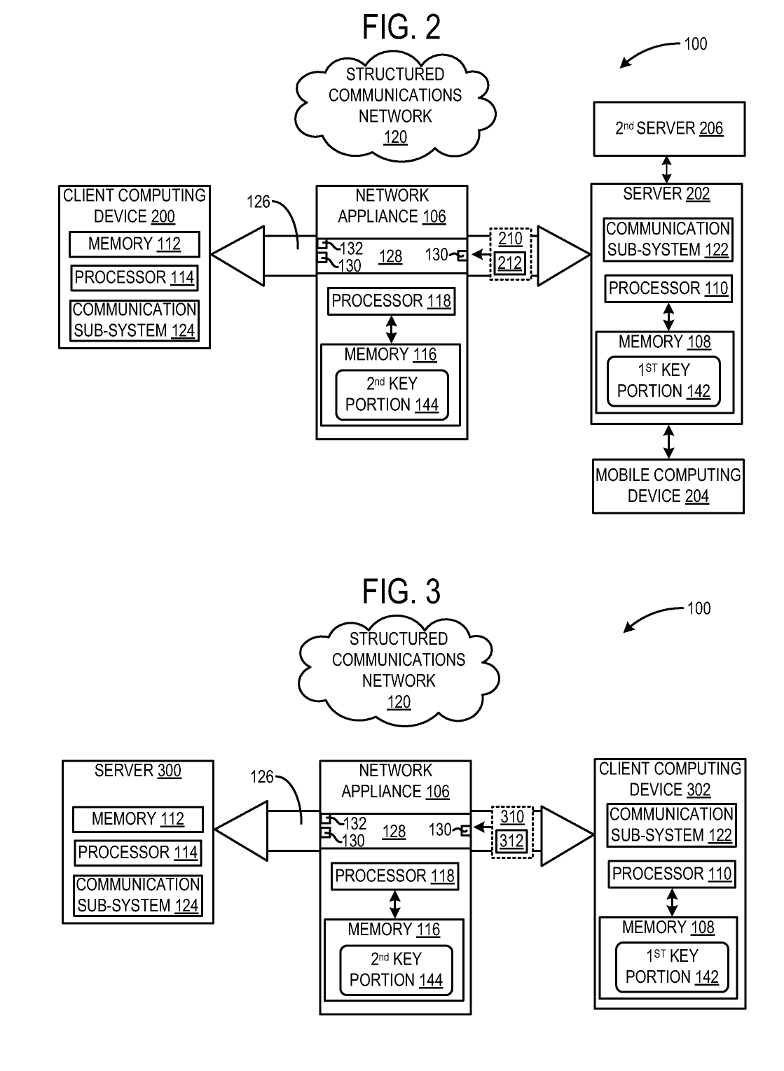

FIG. 2 shows another embodiment of the computing system 100 shown in FIG. 1. In the depicted embodiment, the target computing device is a client computing device 200 and the control computing device is a server 202. The network appliance 106 shown in FIG. 2 has the same components and functionality of the network appliance 106 described above with regard to FIG. 1. The client computing device 200 may initiate communication with the server 202 via standard network protocols. In response, the server 202 may send a communication packet 210 having an embedded control command 212 to the client computing device 200 via the communication path 126. The network appliance 106 then recognizes the control command and in response to the recognition the control command controls the network appliance 106. In some examples, a mobile computing device 204 (e.g., laptop, smart-phone, etc.) may send a request to the server 202 to send a communication packet containing a control command to the client computing device 200. In this way, the controlling the network appliance 106 may be remotely triggered. The server 202 may also communicate with a second server 206 via the structured communications network 120. Therefore, in some examples, the server 202 may act as an intermediary between the client computing device 200 may and the second server 206.

FIG. 3 shows another embodiment of the computing system 100 shown in FIG. 1. In the depicted embodiment, the target computing device is a server 300 and the control computing device is a client computing device 302. The network appliance 106 shown in FIG. 3 has the same components and functionality of the network appliance 106 described above with regard to FIG. 1. In the depicted embodiment, the client computing device 302 may send a communication packet 310 having an embedded control command 312 to the server 300 via the communication path 126. The control command 304 is recognized via the network appliance and in response the control command controls the network appliance 106. In this way, the network appliance 106 is controlled via the client computing device 302. It will be appreciated, that the network appliance and the client computing device 302 may be co-located in a room, building, etc.

FIGS. 4A-4C shows a method 400 for controlling a network appliance. As shown method 400 is implemented via the key manufacturing device 134, the network appliance 106, the control computing device 102, and the target computing device 104, described above with regard to FIGS. 1-3. However, in other embodiments the method 400 may be implemented by other suitable computing devices, network appliances, etc.

Referring to FIG. 4A, at 402 the method includes generating a master key having two mated portions at the key manufacturing device. Next at 404 the method includes, at the key manufacturing device, sending a first portion of the master key to the network appliance and at 406 the method includes receiving the first key portion of the master key at the control computing device. Next at 408 the method includes, at the key manufacturing device, sending a second portion of the master key to the network appliance and at 410 receiving the second key portion of the master key at the network appliance. As discussed above the first and second key portions are mated.

At 412 the method includes at the network appliance, configuring the network appliance so that it cannot be addressed using network communication protocols. Next at 414 the method includes deploying the network appliance so that is communication sub-system is positioned in the communication path.

Moving to FIG. 4B, at 414 the method includes monitoring a data stream in a communication path electronically connecting the control computing device to the target computing device via the network appliance.

Next, at 416 the method includes receiving the address of the target computing device in the network at the control computing device. Next at 418 the method includes encrypting a control command using the first key portion at the control computing device and at 420 the method may optionally include embedding the control command in a communication packet via the control computing device. However, in other embodiments step 420 may be omitted from method 400.

Next at 422 the method includes transmitting the control command to the target computing device and at 424 receiving the control command via the control computing device. At 426 the method includes determining that a control command is present in the data stream sent through the communication path at the target computing device.

Moving to FIG. 4C, at 428 the method includes affirmatively determining that the control computing device and the network appliance possess mating key portions at the network appliance. Step 428 may include at 430 decrypting the encrypted control command using the first key portion.

Next at 432 the method includes permitting the control command to control the network appliance only in response to an affirmative determination via the network appliance. As discussed above, controlling the network appliance may include controlling an operation associated with a computer-activity-recording capability of the network appliance. Controlling the network appliance may also include managing data on the network, managing including deleting, modifying, copying, overwriting, and moving data. Controlling the network appliance may further include controlling one or more devices that are external to the network appliance. In this way, the network appliance may be securely control via the control computing device without disclosing the location of the network appliance. As a result, the security of the network appliance may be increased when compared to appliances that are addressable in a structured communication network such as a VPN.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A network appliance comprising:
an un-addressable communication sub-system positioned in a communication path electronically connecting a control computing device to a target computing device that are both addressable via one or more standard networking protocols that can employed to achieve addressed communications in a structured communications network, the un-addressable communication sub-system being configured to access a data stream traveling through the communication path; and
memory comprising code executable by a processor to:
determine that a control command is present in the data stream; and
permit the control command to control the network appliance only in response to an affirmative determination that the control computing device and the network appliance possess mating key portions, the mating key portions being constructed from a master key.

2. The network appliance of claim 1, where the master key has a format that does not conform to pre-defined network standards.

3. The network appliance of claim 2, where the pre-defined network standards include a length of the key, a key sequence, and a type of key encryption.

4. The network appliance of claim 1, where the control command is embedded in a communication packet.

5. The network appliance of claim 4, where the communication packet is one of a malformed packet and an Internet protocol (IP) packet.

6. The network appliance of claim 1, where an affirmative determination that the control computing device and the network appliance possess mating key portions includes decrypting the control command using a first key portion stored in the memory.

7. The network appliance of claim 1, where controlling the network appliance includes controlling an operation associated with a computer-activity-recording capability of the network appliance.

8. The network appliance of claim 1, where controlling the network appliance includes managing data on the structured communications network, managing including deleting, modifying, copying, overwriting, and moving data.

9. The network appliance of claim 1, where controlling the network appliance includes controlling one or more devices that are external to the network appliance.

10. The network appliance of claim 9, where the one or more devices that are external to the network appliance include at least one device that controls or manages physical security of a structure.

11. The network appliance of claim 9, where the one or more devices that are external to the network appliance is a printer.

12. The network appliance of claim 1, where the control computing device is a server and the target computing device is a client computing device.

13. The network appliance of claim 12, wherein controlling the network appliance includes initiating two-way communication between the client computing device and the network appliance.

14. A computing system for securely controlling a network appliance, comprising:
a target computing device positioned in a structured communications network and addressable via one or more standard networking protocols that can be employed to achieve addressed communications in the structured communications network;
a control computing device addressable via one or more standard networking protocols that can employed to achieve addressed communications in the structured communications network and positioned in the structured communications network comprising:
a first key portion stored in memory executable by a processor and constructed from a master key, the master key being in a format that does not conform to pre-defined network standards; and
the memory comprising code executable by the processor to send a control command to the target computing device via a communication path electronically connecting the control computing device to the target computing device; and
the network appliance comprising:
an un-addressable communication sub-system positioned in the communication path, the un-addressable communication sub-system being configured to access a data stream traveling through the communication path;
a second key portion stored in memory, constructed from the master key, and mated with the first key portion; and
the memory comprising code executable by a processor to:
determine that the control command is present in the data stream; and
permit the control command to control the network appliance only in response to an affirmative determination that the control computing device and the network appliance possess mating key portions.

15. The computing system of claim 14, where the control command is embedded in a communication packet, the communication packet is one of an Internet protocol (IP) packet and a malformed packet.

16. The computing system of claim 14, where the control computing device further includes memory comprising code executable by the processor to encrypt the control command using the first key portion.

17. The computing device of claim 16, where an affirmative determination that the control computing device and the network appliance possess mating key portions includes decrypting the encrypted control command using the first key portion.

18. The computing system of claim 17, wherein an encryption algorithm implemented via the first key portion and a decryption algorithm implemented via the second key portion are altered at predefined time intervals.

19. A method for securely controlling a network appliance comprising:
at a network appliance un-addressable in a structured communications network and positioned in a communication path electronically connecting a control computing device to a target computing device that are both addressable via one or more standard networking protocols that can employed to achieve addressed communications in the structured communications network, determining that a control command is present in a data stream sent through a communication path; and
permitting the control command to control the network appliance only in response to an affirmative determination that the control computing device and the network appliance possess mating key portions, the mating key portions being constructed from a master key.

20. The method of claim 19, further comprising at the control computing device, prior to the step of determining that the control command is present in the data stream, transmitting the control command through the communication path.

21. The method of claim 20, further comprising prior transmitting the control command through the communication path, deploying the network appliance so that is communication sub-system is positioned in the communication path.

22. The method of claim 19, further comprising, prior to transmitting the control command, generating the master key, configuring the network appliance so that it cannot be addressed using network communication protocols, receiving a first key portion at the network appliance, and receiving a second key portion mated with the first key portion at the control computing device.

23. The method of claim 22, where the master key is generated with any of a variety of formats, including formats that do not conform to pre-defined networking standards.

24. The method of claim 19, wherein the control command is embedded in at least one of an Internet protocol (IP) packet and malformed packet.
